(19) United States
(12) Patent Application Publication
(10) Pub. No.: US 2021/0107805 A1
(43) Pub. Date: Apr. 15, 2021

(54) Water Pitcher Filter

(71) Applicant: Qingdao Ecopure Filter Co., Ltd, Qingdao (CN)

(72) Inventor: Zou Zhibin, Qingdao (CN)

(21) Appl. No.: 16/600,880

(22) Filed: Oct. 14, 2019

(51) Int. Cl. C02F 1/00; C02F 1/28; C02F 1/42

(52) U.S. Cl. CPC C02F 1/003; C02F 1/281; C02F 2307/04; C02F 1/42; C02F 1/283

(57) ABSTRACT

A water pitcher filter is provided. The filer includes a filter body formed from a bottom case and a top cap. The bottom case is adapted to retain filtration medium therein. The top cap includes an upper surface having an air outlet, a lower surface to engage the bottom case, a sidewall extending between the upper and lower surface and around a perimeter of the top cap, a nonwoven or net portion disposed on the sidewall and/or lower surface to allow unfiltered water to pass therethrough. The top case also includes a vent tube extending between the upper and lower surface and having a vent opening into the bottom case at the lower surface. In operation water passes through the nonwoven portion and into the bottom case where the filtration medium filters the unfiltered water and disposes filtered water into a filtered water chamber of a water pitcher.

### TECHNICAL FIELD

The present disclosure relates generally to pitchers for dispensing/pouring fluids and/or liquids therefrom, and more particularly, to a filter used with the pitcher to treat the fluids and/or liquids dispensed therefrom.

### BACKGROUND

Water filtration systems, e.g., gravity flow water filtration systems, have become popular as they assist to produce cleaner and better tasting water. Some of these water filtration systems (e.g., a pour-through water pitcher filtration system) typically uses gravity to move unfiltered water pour through a top of the pitcher through a filter (e.g., a water filtration cartridge) and into a lower part of the pitcher where the filtered water remains until it is used. Traditional water filter cartridges used for gravity flow systems use granular filtration media to enhance water filtration capability. A problem associated with using granular filtration media is that air gets trapped in-between the particles of filtration media and the area above the fill line of the filtration media. This air must be vented from the water filter cartridge as water is filtered or water flow will be slowed or completely stopped.

Accordingly, a need exists for an improved filter to further enhance water filtration and to improve flow rates which may be slowed due to the above filtration media and/or venting issues.

### SUMMARY

In an exemplary embodiment, a pitcher for dispensing or otherwise pouring fluids and/or liquids therefrom is provided. The filer includes at least a filter body formed from a bottom case and a filter cap. The bottom case is adapted to retain filtration medium therein. The filter cap includes an upper surface having an air outlet, a lower surface to engage the bottom case, a sidewall extending between the upper and lower surface and around a perimeter of the filter cap, a nonwoven or net portion disposed on the sidewall to allow unfiltered water to pass therethrough. The filter cap also includes a vent tube extending between the upper and lower surface and having a vent opening into the bottom case at the lower surface. In operation water passes through the nonwoven portion and into the bottom case where the filtration medium filters the unfiltered water and disposes filtered water into a filtered water chamber of a water pitcher.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the present disclosure will become better understood with regard to the following description and accompanying drawings in which:

FIG. 1 illustrates an exemplary embodiment of a pitcher in accordance with the disclosure provided herein;

FIG. 2 illustrates an exemplary embodiment of a filter assembly for use with exemplary embodiments of a pitcher in accordance with the disclosure provided herein;

FIG. 3 illustrates another exemplary embodiment of a filter assembly for use with exemplary embodiments of a pitcher in accordance with the disclosure provided herein;

FIG. 4 illustrates a further exemplary embodiment of a pitcher in accordance with the disclosure provided herein;

FIG. 5 illustrates a further exemplary embodiment of a filter assembly in accordance with the disclosure provided herein;

FIG. 6 illustrates a cross-sectional view of the filter assembly of FIG. 5;

FIG. 7A illustrates a second cross-sectional view of the filter assembly of FIG. 5;

FIG. 7B illustrates another cross-sectional view of the filter assembly of FIG. 7A;

FIG. 8A illustrates an exploded view of yet another exemplary embodiment of a filter assembly in accordance with the disclosure provided herein; and

FIG. 8B illustrates a top view of an exemplary embodiment of a cover in accordance with the disclosure provided herein.

### DETAILED DESCRIPTION

Aspects and implementations of the present disclosure will be understood more fully from the detailed description given below and from the accompanying drawings of the various aspects and implementations of the disclosure. This should not be taken to limit the disclosure to the specific aspects or implementations, but explanation and understanding only.

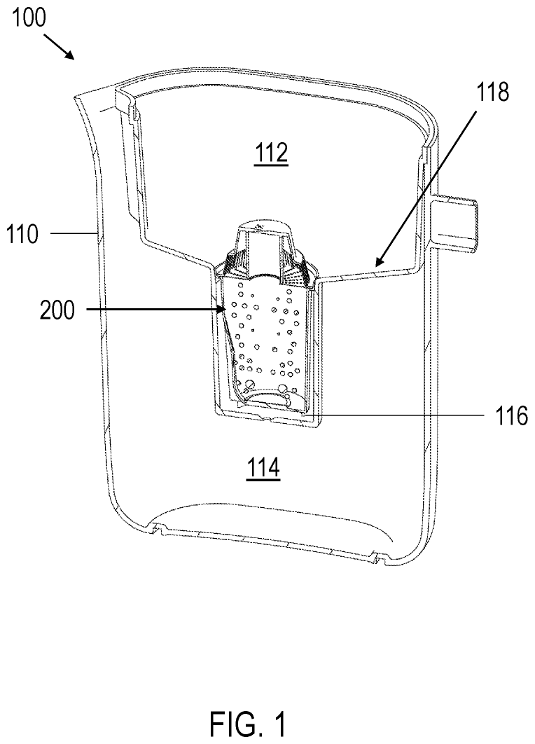

Referring now to the drawings, which are for purposes of illustrating exemplary embodiments of the subject matter herein only and not for limiting the same, FIG. 1 shows an exemplary embodiment of a water pitcher 100 (e.g., a water pitcher 100).

As shown in FIG. 1, the water pitcher 100 may include at least a container 110, and a cover (not shown) adapted for covering an opening of the container 110. The container 110 may be adapted or otherwise shaped for retaining fluids and/or liquid substances (e.g., water) therein. It should be appreciated that the embodiments of the water pitcher 100 described herein may be used for any fluids and/or liquid substances, and that references to water herein are for exemplary purposes only, and not for limiting said water pitcher 100 to a particular fluid and/or liquid substance.

In some embodiments, the container 110 may define a cavity for retaining water therein. The cavity may define or otherwise include one or more chambers for retaining and/or processing (e.g., filtering) water therein. In the exemplary embodiment of FIG. 1, the container 110 includes at least an upper chamber 112 and a lower chamber 114. The upper chamber 112 may be an unfiltered water chamber for receiving unfiltered water therein. The lower chamber 114 may be a filtered water chamber where the processed (i.e., filtered) unfiltered water of the upper chamber 112 is stored until used after flowing at least partially through a filter assembly 200 (also referred to herein as a filter).

In some embodiments, the upper chamber 112 may be integrally formed with the lower chamber 114 such that both chambers define the cavity for retaining water. Additionally, or alternatively, the upper chamber 112 may be a separate compartment from the lower chamber 114. In these embodiments, the upper chamber 112 may be removable and selectively placed or otherwise installed within the cavity of the container's 110 for receiving unfiltered water therethrough. In some embodiments, the upper chamber 112 and lower chamber 114 may be formed from the same materials, or in a further exemplary embodiment, the upper chamber 112 may be formed of different materials that the lower chamber 114.

With continued reference to the figures, the upper chamber 112 may include or otherwise define a filter chamber 116. The filter chamber 116 may be adapted or otherwise sized for receiving a filter assembly 200 (also referred to herein as a filter) at least partially therein.

In some embodiments, the unfiltered water within the upper chamber 112 may be separated from the filtered water within the lower chamber 114 via an upper chamber wall 118. It should be appreciated that the upper chamber wall 118 may include one or more openings 120 adapted or otherwise sized for feeding filtered water into the lower chamber 114 once the unfiltered water has passthrough the upper chamber 112 and has been filtered via the filter assembly 200.

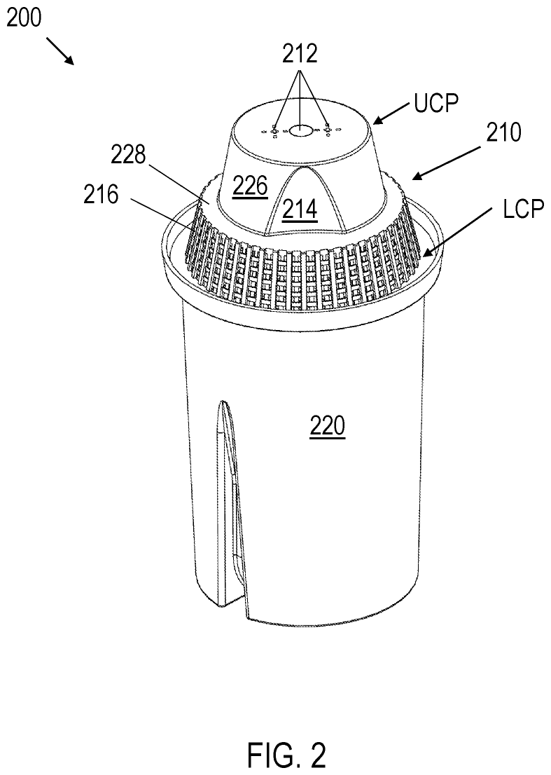

In some embodiments, for example, as shown in FIG. 2, the opening 120 may be formed in the upper chamber wall 118 at a bottom of the filter chamber 116. It should be appreciated that the opening 120 may be formed at other points along the upper chamber wall 118 where the filter assembly 200 may be placed for filtering unfiltered water.

With continued reference to the figures, and now with reference to FIG. 2, the filter assembly 200 may include a filter cap 210 adapted or otherwise shaped for covering a filter body 220 or similar casing. The filter assembly 200 may be sized or otherwise shaped for being removably installed or otherwise placed in the container 110, e.g., at a bottom or lower part of the container 110, or in the filter chamber 116.

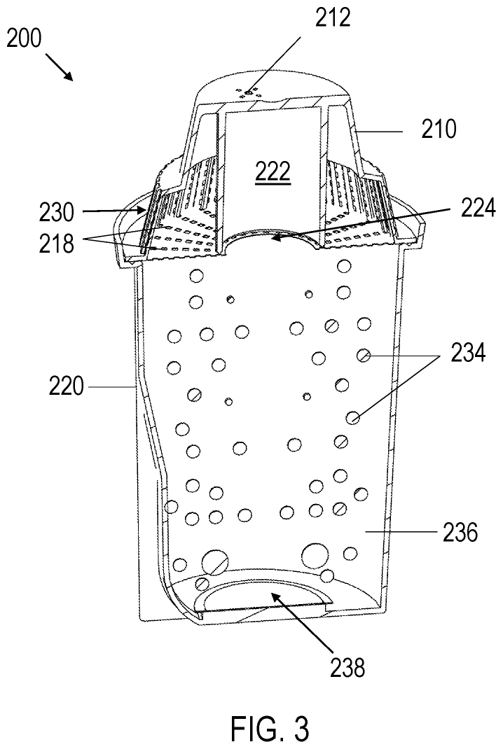

The filter body 220 may be adapted or otherwise shaped for retaining one or more filtering materials (also referred to as filtering medium) 232 (FIG. 3) therein and for filtering any fluids and/or liquids (e.g., water) flowing through the filter body 220 and into the lower chamber 114.

Examples of the filtering materials 232 may include alumina balls, activated carbon, ion-exchange resin, and/or combinations thereof, or other filtering materials 232 known to persons of ordinary skill in the art and capable of being retained or otherwise contained in the filter body 220. In the embodiment of FIG. 3, a plurality of filtering materials 232 (e.g., alumina balls) may be suspended in and/or mixed with solid active carbon and resin 234.

It should be appreciated that the filter body 220 may include a filter body opening 238 or similar outlet for passage of filtered water, for example, into the lower chamber 114. In some embodiments, the filter body opening 238 may be defined at a lower part of the filter body 220 to allow for the water that has been filtered via the filtering materials 232 to flow from the filter body 220 into the lower chamber 114. In some embodiments, the filter body opening 238 may be aligned with the opening 120 of the upper chamber wall 118.

With continue reference to the figures, and now with reference to the FIG. 3, the filter cap 210 may define an upper cap portion UCP and a lower cap portion LCP. In some embodiments, the filter cap 210 may include one or more apertures, openings, or the like, formed in the upper portion. As shown in the embodiment of FIG. 2 a first opening may be provided at the upper cap portion (e.g., at a top of the filter cap) as an air outlet 212. In some embodiments, the air outlet 212 may extend through the top of the filter cap to allow for air to escape during the filtering and/or venting process.

In some embodiments, e.g., the filter cap 210 may include a recessed portion 214 or similar depression and/or void in a portion of the filter cap 210 for handling of the filter assembly 200 (e.g., by a user. The recessed portion 214 may be smooth and/or textured. Additionally, or alternatively, the recessed portion 214 may be formed from similar materials to the materials forming the filter cap 210, or in some embodiments, may be formed from materials having one or more differences that the materials forming the filter cap 210.

With continued reference to the figures, the filter cap 210 may include an air or vent tube 222 to assist with the filtering and/or venting process. In some embodiments, the vent tube 222 may be cylindrically shaped and may extend from the upper cap portion (UCP) towards the lower cap portion (LCP). It should be appreciated that non-cylindrically shaped vent tubes 222 may also be used for the filtering and/or venting process.

In some embodiments, the vent tube 222 may include a vent opening 224 at the lower cap portion. The vent opening 224 may open into the filter body 220, and with minimal to no restriction, e.g., via a meshed and/or a nonwoven or net portion 216, to allow for air to vent, e.g., via the vent opening 224.

Additionally, or alternatively, the filter cap 210 may also include the nonwoven or net portion 216 formed along one or more sides (e.g., sidewalls) of the filter cap 210. In some embodiments, the filter cap 210 may a first sidewall 226 extending from an upper surface (top surface) of the filter cap 210 towards a lower surface (bottom surface) of the filter cap 210. In some embodiments, the first sidewall 226 tapers from the top surface towards the bottom surface such that an upper portion of the first sidewall 226 has a diameter less than the lower portion of the first sidewall 226.

Additionally, or alternatively, the first sidewall 226 (e.g., a tapered first sidewall 226) may include a flange or similar platform 228 extending (e.g., protruding) outwardly therefrom and defining a second sidewall 230 between the platform 228 and the lower surface of the filter cap 210. It should be appreciated that the diameter of the second sidewall 230 may be larger than the diameter of the first sidewall 226. It should further be appreciated that the second sidewall 230 may taper downwardly from the platform 228 towards the lower surface of the filter cap 210 such that a perimeter of an upper portion of the second sidewall 230 closes to the platform 228 is less than a diameter of a lower portion of the second sidewall 230 closes to the lower surface of the filter cap 210.

With continued reference to the figures, the nonwoven portion 216 of the filter cap 210 may be configured to sealing engage or otherwise connect the first sidewall 226 and/or second sidewall 230 and the vent tube 222. In some embodiments, the nonwoven or net portion 216 may be included only on one of the filter cap 210 sidewalls (e.g., the first sidewall 226 or the second sidewall 230). In the embodiment of FIG. 2 and FIG. 3, the nonwoven or net portion 216 is shown on the second sidewall 230 beneath the platform 228. It should be appreciated that the nonwoven or net portion 216 may be included on the first sidewall 226 in lieu of it being provided on the second sidewall 230. In this embodiment, at least a portion of the first sidewall 226 may include the nonwoven portion 216.

In some embodiments, the nonwoven portion 216 may include a plurality of openings (also referred to as inlets or water inlets 218 extending through the sidewalls. The water inlet 218 may be formed in the sidewall of the filter cap 210, and in some embodiments, around a perimeter of either the upper cap portion, the lower cap potion, or a combination of both. The water inlet 218 may be provided around the entire perimeter of the filter cap 210, or in some embodiments, at least a portion of the perimeter of either the upper cap portion UCP, the lower cap portion LCP, or a combination of both. In the embodiment of FIG. 2 and FIG. 3, the water inlet 218 extends around the perimeter of the lower cap portion LCP, e.g., on the second sidewall 230 of the filter cap 210.

Additionally, or alternatively, the nonwoven portion may further be disposed on an underside of the filter cap 210 (e.g., on a bottom surface) where the filter cap 210 engages the filter body 220. In this embodiment, the nonwoven portion 216 may cover the bottom surface of the filter cap 210. Additionally, or alternatively, the nonwoven portion may cover around a perimeter of the vent opening 224 of the air vent and not the vent opening 224 (i.e., the vent opening 224 may not include a nonwoven portion 216 at the bottom surface). It should be appreciated that removing any restrictions from the vent opening 224 may improve air ventilation of the filter assembly 200.

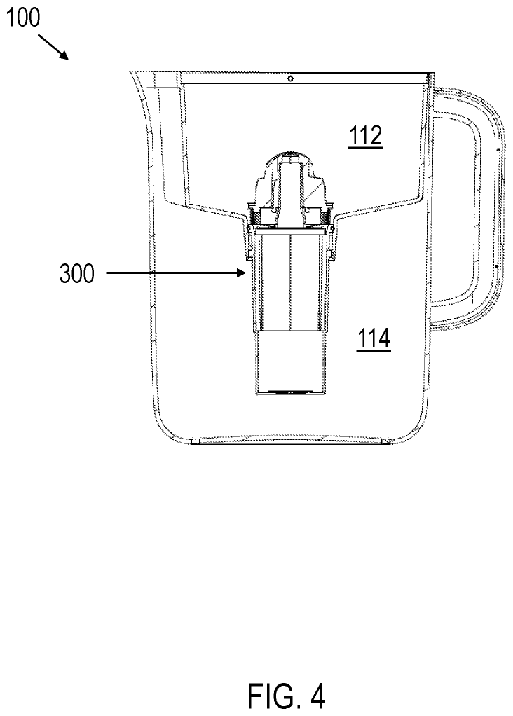

With continue reference to the figures, and now with reference to FIG. 4, yet a further exemplary embodiment of a water pitcher 100 is provided. In this embodiment, the upper chamber 112 may configured such that a further embodiment of a filter assembly 300 may be removably secured or otherwise suspended between an opening in the upper chamber 112 resulting in at least a portion of the filter assembly 300 being situated in the upper chamber 112, while the remaining portion is situated in the lower chamber 114.

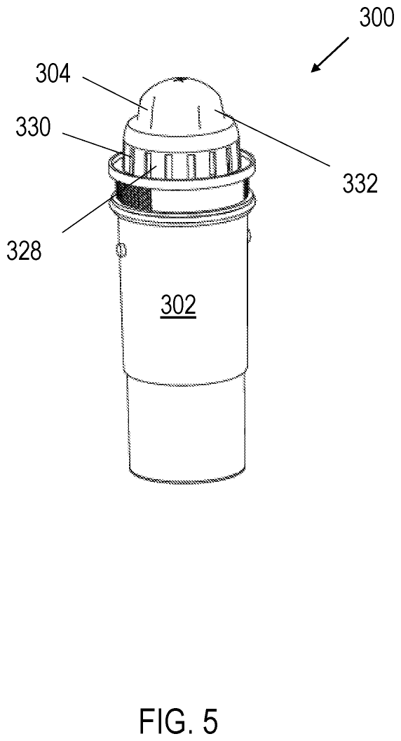

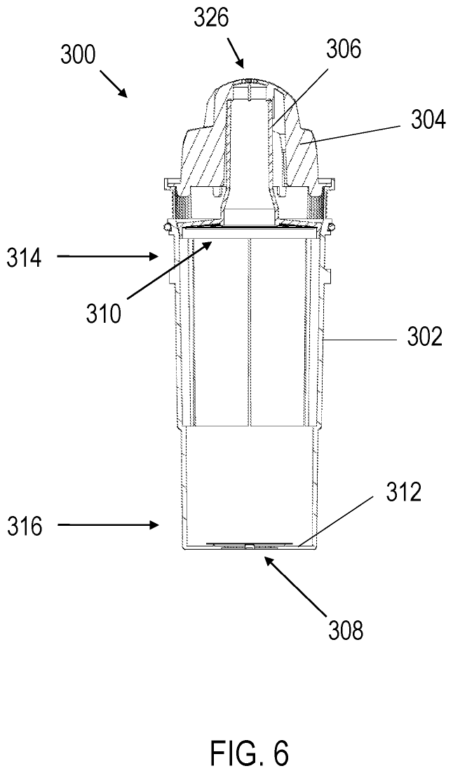

With reference now to FIG. 5 and FIG. 6, the filter assembly 300 may include a filter body or casing 302, a cover 304, and a vent part 306. The casing 302 may be sized or otherwise shaped for retaining the filtering materials 232 therein. It should be appreciated that the casing 302 may include a first opening 308 or similar outlet at a lower part of the casing (i.e., a lower part of the casing 302 when installed in an upright water pitcher 100). The first opening 308 at the lower part of the casing may be sized or otherwise shaped to allow for passage of filtered water (i.e., water that has passed through the filtering materials 232) into the lower chamber 114.

With continue reference to the figures the casing 302 further includes a first end 314, a second end 316, and a second opening 310 at the first end opposite the first opening 308 defined at the lower part (e.g., a base 312) of the casing 302. It should be appreciated that the second opening 310 at the first end 314 may be sized such that the filtering material 232 may be disposed therethrough and into the casing 302. It should further be appreciated that the first opening at the base 312 may be smaller than the second opening 310 and may be sized or otherwise shaped to restrict movement of the filtering material 232 and/or any other parts of the filter assembly 300 from entering into the lower chamber 114 during the filtering process.

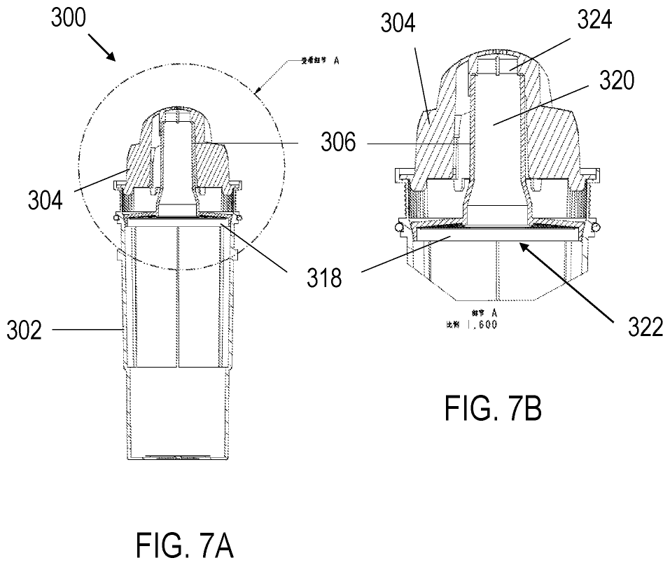

With reference now to FIG. 7A and FIG. 7B the vent part 306 may include a vent base 318 and an air vent 320 or similar channel extending from the vent base 318 in an opposite direction from the first end 314 of the casing 302. The vent base 318 may be sized or otherwise shaped for at least partially covering the second opening 310 at the first end 314. In some embodiments, the air vent 320 may be tubular and may taper from an upper portion of the air vent 320 proximate to a top of the cover 304 towards the vent base 318.

Additionally, or alternatively, the air vent 320 may include a first vent opening 322 at the base for air to pass from the casing 302 through the first vent opening 322 and towards a second vent opening 324 opposite the first vent opening 322. In some embodiments, the second vent opening 324 may be smaller than the first vent opening 322.

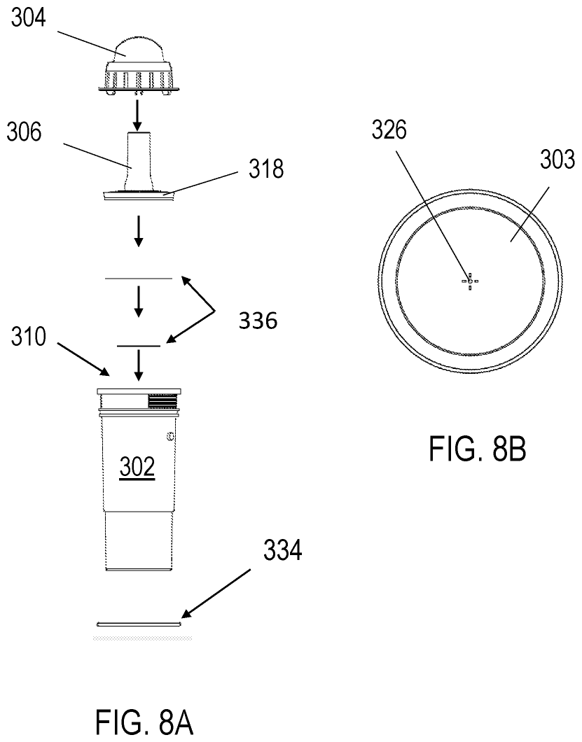

With continue reference to the figures, and now with reference to FIG. 8A and FIG. 8B, the cover 304 may be configured to cover at least a portion of the vent part 306. Additionally, or alternatively, the cover 304 may be configured to interface with portions of the casing 302 for removably securing the cover 304 to the casing 302 and/or another part of the filter assembly 300 for securing the contents of the filter assembly 300 therein. In some embodiments, the cover may cover at least a portion of the vent base 318 and the air vent 320. Additionally, or alternatively, the entire air vent 320 may be enclosed by the cover 304 when installed.

In some embodiments, the cover 304 may include one or more openings extending through a thickness of the cover 304. At least one of the cover 304 openings 326 may be a cover vent opening 326. The cover vent opening 326 may be positioned or otherwise situated on the cover 304 (e.g., at a top of the cover 304) to align the cover vent opening 326 with second vent opening 324 and the first vent opening 322 to allow for air from the casing 302 to pass therethrough via the air vent 320.

In some embodiments, a sealing ring 334 may be provided for providing a seal when placing the filter assembly 300 within the water pitcher 100. It should be appreciated that the sealing ring 334 may be included with the water pitcher 100, or in some embodiments, as part of the filter assembly 300. The sealing ring 334 may include an opening (not shown) sized or otherwise shaped to at least partially receiving the filter assembly 300 therebetween. It should further be appreciated that the sealing ring 334 may be provided to restrict or otherwise limit unfiltered water from entering the filtered water chamber (e.g., the lower chamber 114).

With continued reference to the figures, the cover 304 may further include one or more side walls 328. At least one side wall 328 may be including one or more of openings (e.g., water inlets) for source water to flow therethrough and into the casing 302. It should be appreciated that source water, as used herein means water from an external source that is poured or otherwise fed into the water pitcher 100 for filtering, e.g., via any of the exemplary embodiments of the filter assembly disclosed herein.

In some embodiments, a second side wall 332 (FIG. 5) may be provided on the cover 304. In this embodiment, the second side wall 332 may not include any openings and may have a arcuate profile. In some embodiments, a shoulder may be defined between the first side wall 330 and the second side wall 332.

In yet a further exemplary embodiment, at least a portion of the vent base 318 may include a nonwoven or net portion. In some embodiments, the entire vent base 318 may include a nonwoven or net portion 336 (FIG. 8A), or similar permeable membrane. Additionally, or alternatively, all of the vent base 318 except for the second opening 310 may include a nonwoven or net portion 336. It should be appreciated that multiple nonwoven or net portions 336 may be provided (two shown in FIG. 8A). In an embodiment where multiple nonwoven or net portions 336 may be provided, each nonwoven or net portion 336 may be the same size, or in some embodiments, different sizes may be provided.

With continue reference to the figures, a gap may be formed between the second vent opening 324 and the cover vent opening 326. The size of the gap may be adjusted for optimal air venting.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, the methods and systems described herein are not limited to the specific details, the representative embodiments, or the illustrative examples shown and described. Accordingly, departures may be made from such details without departing from the spirit or scope of the general aspects of the present disclosure.

We claim:

1. A water pitcher comprising:
a container adapted for receiving unfiltered water therein; and
a filter disposed at a bottom of the container, wherein the filter includes:
a casing and a top cap; and
a filtration medium disposed in the casing;
wherein the top cap includes:
a top surface, a bottom surface, and a sidewall disposed between the top surface and the bottom surface and extending around a perimeter of the top cap;
a vent tube extending from the top surface towards the bottom surface;
an air outlet extending from the vent tube through a top surface of the top cap; and
a nonwoven or net portion disposed on at least a portion of the bottom surface, wherein the nonwoven or net portion sealingly connects the sidewall and the vent tube.

2. The pitcher of claim 1, further comprising:
a cover adapted to cover at least a portion of an opening of the container.

3. The pitcher of claim 1, wherein the filtration medium is selected from one or more of an alumina ball, activated carbon, and ion-exchange resin.

4. The pitcher of claim 1, wherein the nonwoven portion of the top cap includes a plurality of water inlets.

5. The pitcher of claim 4, wherein the air outlet is separated from each of the water inlets.

6. The pitcher of claim 1, wherein the air outlet is sized to retain the filtration medium within the filter.

7. The pitcher of claim 1, wherein vent tube is cylindrically shaped.

8. A water pitcher filter comprising:
a casing and a top cap;
wherein the casing is adapted to retain filtration medium therein;
wherein the top cap is adapted to cover the casing, and includes:
an upper surface having an air outlet extending therethrough;
a lower surface adapted to engage the casing,
a sidewall extending between the upper surface and the lower surface and around a perimeter of the top cap;
a nonwoven or net portion disposed on at least a portion of the lower surface, wherein the nonwoven or net portion is adapted to allow unfiltered water to pass therethrough; and
a vent tube extending between the upper surface and lower surface and including a vent opening into the casing at the lower surface.

9. The water pitcher filter of claim 8, wherein the vent tube is cylindrically shaped.

10. The water pitcher filter of claim 9, wherein the vent tube is aligned air outlet to allow for air to exit the filter via the air outlet.

11. The water pitcher filter of claim 8, wherein the nonwoven portion is further disposed on the lower surface and at least partially around a perimeter of the vent opening such that the vent opening does not include the nonwoven portion.

12. The water pitcher filter of claim 1, wherein the filtration medium is selected from one or more of an alumina ball, activated carbon, and ion-exchange resin.

13. The water pitcher filter of claim 1, wherein the nonwoven portion includes a plurality of water inlets.

14. The water pitcher filter of claim 13, wherein the air outlet is separated from each of the water inlets.

15. The water pitcher filter of claim 1, wherein the air outlet is sized to retain the filtration medium within the filter.

16. A water filter comprising:
a casing, a cover, and a vent part;
wherein the casing retains a filtering media therein and has a first end, a second end, and an opening at the first end;
wherein the vent part includes a base at least partially covering the opening at the first end and an air vent extending from the base in an opposite direction from the first end of the casing, wherein the air vent includes a first opening at the base for air to pass from the casing through the first opening and towards a second opening at an opposite end of the air vent from the first opening;
wherein the cover covers the vent part and at least a portion of the base and includes a vent opening, and wherein the vent opening is aligned with second opening and the first opening to allow for air from the casing to pass therethrough via the vent tube.

17. The water filter of claim 16, wherein the cover further comprises:
a side wall including a plurality of openings for source water to flow therethrough and into the casing.

18. The water filter of claim 17, wherein the source water passes through at least a portion of the base that includes a nonwoven or net portion.

19. The water filter of claim 18, wherein the first opening at the base is the portion of the base that does not include the nonwoven or net portion.

20. A water pitcher filter comprising:
a water filter in accordance with claim 16.
